(19) United States
(12) Patent Application Publication
(10) Pub. No.: US 2006/0109654 A1
(43) Pub. Date: May 25, 2006

(54) Stem mount for light emitting diode

(76) Inventors: Charles M. Coushaine, Rindge, NH (US); Michael Tucker, Henniker, NH (US); Thomas Tessnow, Weare, NH (US)

Correspondence Address: OSRAM SYLVANIA Inc., 100 Endicott Street, Danvers, MA, 01923, US

(21) Appl. No.: 10/995,855

(22) Filed: Nov. 23, 2004

(51) Int. Cl. F21V 29/00

(52) U.S. Cl. 362/294

(57) ABSTRACT

A lamp assembly (10) that comprises a reflector (12) for directing light in a given direction. An aperture (14) is formed in the reflector (12), substantially in the base thereof, and a thermally conductive post (16) is fitted in the aperture (14) and has a first surface (18) within the reflector and a second surface (20) outside of the reflector. The post (16) is preferably a metal such as copper. A single, side emitting, LED light source (22) is fixed to the first surface (18), preferably via an electrically insulating but thermally conductive member (23). A heat sink (24) is fixed to the second surface (20) and preferably is an inherent part thereof to insure good heat conductivity between the post (16) and the heat sink (24). Circuitry (26), which can be mounted on a printed circuit board, is associated with the LED source (22) for supplying power thereto. Suitable electrical connections, not shown, can be supplied from the circuitry (26) to the LED light source (22) via insulated wires running up the side of the post (16) or threaded through longitudinal apertures formed in the post (16). Alternatively, an electrically insulating material supplied with conductive traces can cover the post (16). The LED light source can include a cap having a secondary reflector thereon or the light source (22) can be covered by a dome-shaped, transparent element having sidewalls and a closed top having at least one metallized surface and including an optic.

This application claims priority from Provisional Patent Application No. 60/______, filed Jul. 16, 2004.

### TECHNICAL FIELD

This invention relates to light sources and more particularly to light sources employing light emitting diodes (LED or LEDs) and more particularly to light sources useful in the automotive field such as for headlights, taillights, stoplights, fog lights, turn signals, etc. Still more particularly, it relates to such light sources packaged to achieve industry

### BACKGROUND ART

In the past, most automotive light sources have involved the use of incandescent bulbs. While working well and being inexpensive, these bulbs have a relatively short life and, of course, the thin filament employed was always subject to breakage due to vibration.

Recently some of the uses, particularly the stoplight, have been replaced by LEDs. These solid-state light sources have incredible life times, in the area of 100,000 hours, and are not as subject to vibration failures. However, these LED sources have been hard-wired into their appropriate location, which increases the cost of installation. It would therefore be an advance in the art if an LED light source could be provided that had the ease of installation of the incandescent light sources.

It would be a still further advance if LED light sources employing single LEDs could be utilized, with such light sources providing acceptable illumination, good heat removal and ease of use.

### DISCLOSURE OF INVENTION

It is, therefore, an object of the invention to obviate the disadvantages of the prior art.

It is another object of the invention to enhance LED light sources.

These objects accomplished, in one aspect of the invention, by the provision of a lamp assembly that has a reflector for directing light in a given direction. The reflector has an aperture therein and a thermally conductive post is fitted into the aperture. The post has a first surface within the reflector and a second surface outside of the reflector. A single, side emitting, LED light source is fixed to the first surface, a heat sink is fixed to the second surface and circuitry is associated with the LED light source for supplying power thereto.

In one embodiment of the invention the light source includes a cap having a second reflector provided thereon and in another embodiment of the invention the light source includes a dome-shaped, transparent element having sidewalls and a closed top having at least one metallized surface. An optic tailored to a specific emission pattern can be included in the transparent element.

### BRIEF DESCRIPTION OF THE DRAWINGS

FIG. 1 is a diagrammatic sectional view of an embodiment of the invention; and

FIG. 2 is a partial, diagrammatic sectional view of an alternate embodiment.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

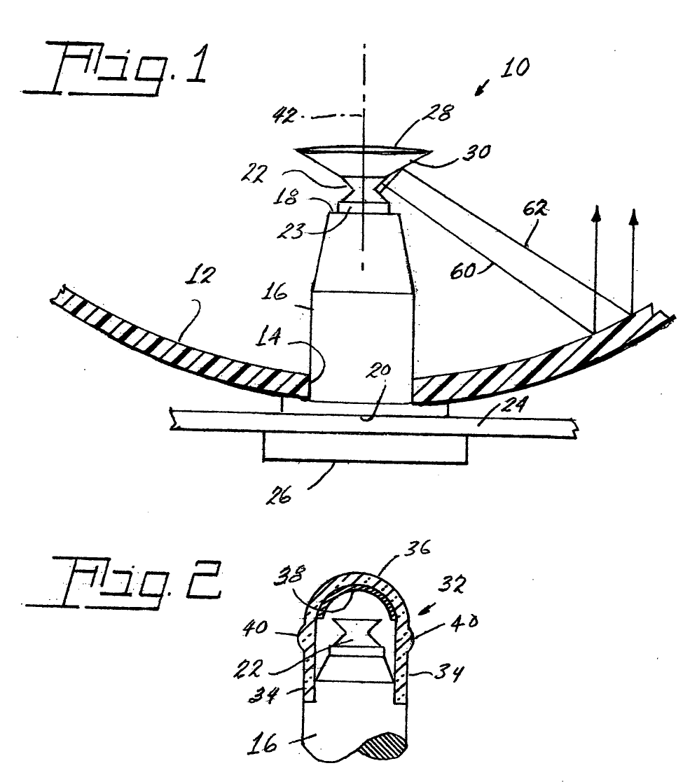

Referring now to the drawings with greater particularity, there is shown in FIG. 1 a lamp assembly 10 that comprises a reflector 12 for directing light in a given direction. An aperture 14 is formed in the reflector, substantially in the base thereof, and a thermally conductive post 16 is fitted in the aperture 14 and has a first surface 18 within the reflector and a second surface 20 outside of the reflector. The post 16 is preferably a metal such as copper. A single, side emitting, LED light source 22 is fixed to the first surface 18, preferably via an electrically insulating but thermally conductive member 23. A heat sink 24 is fixed to the second surface 20 and preferably is an inherent part thereof to insure good heat conductivity between the post 16 and the heat sink 24. Circuitry 26, which can be mounted on a printed circuit board, is associated with the LED light source 22 for supplying power thereto and preferably is mounted outside of the reflector. Suitable electrical connections, not shown, can be supplied from the circuitry 26 to the LED light source 22 via insulated wires running up the side of the post 16 or threaded through longitudinal apertures formed in the post 16. Alternatively, an electrically insulating material supplied with conductive traces can cover the post 16.

The light source 22 can be mounted alone atop the post 16 or it can have a cap 28 that includes a secondary reflector 30 mounted thereon. With a cap 28 in place, during operation the LED light source can emit light rays directly to the reflector 12, as shown by arrow 60, or the light rays can be emitted toward the second reflector 30 and redirected toward the reflector 12, as shown diagrammatically by the arrow 62.

Alternatively, the LED light source 22 can be covered by a dome-shaped, transparent element 32 having sidewalls 34 and a closed top 36 having at least one metallized surface 38. The sidewalls 34 can include at least one optic 40, which can take the form of a molded-in lens tailored to provide a specific emission pattern.

The post 16 has a given length measured along a longitudinal axis 42 whereby the LED light source 22 is positioned at a focal point of the reflector 12.

The reflector 12 can be any desired shape but for use as an automotive taillight assembly is preferably concave. Still more particularly, the shape can be a parabolic section.

Thus there is provided a single LED light source suitable for an automotive taillight assembly having easy installation and good heat removal. Additional optics can be employed to achieve customized light emission.

While there have be shown and described what are present considered to be the preferred embodiments of the invention, it will be apparent to those skilled in the art that various changes and modifications can be made herein without departing from the scope of the invention as defined by the appended claims.

What is claimed is:

1. A lamp assembly comprising:
a reflector for directing light in a given direction;
an aperture in said reflector;
a thermally conductive post fitted in said aperture having a first surface within said reflector and a second surface outside of said reflector;
a single, side emitting, LED light source fixed to said first surface;
a heat sink fixed to said second surface; and
circuitry associated with said LED light source for supplying power thereto.

2. The lamp assembly of claim 1 wherein said LED light source includes a cap having a secondary reflector thereon.

3. The lamp assembly of claim 1 wherein said LED light source is covered by a dome-shaped, transparent element having sidewalls and a closed top having at least one metallized surface.

4. The lamp assembly of claim 3 wherein said sidewalls include at least one lens.

5. The lamp assembly of claim 1 wherein said post has a given length measured along a longitudinal axis.

6. The lamp assembly of claim 5 wherein said given length positions said LED light source at a focal point of said reflector.

7. The lamp assembly of claim 6 wherein said reflector is concave.
